(19) United States
(12) Patent Application Publication
(10) Pub. No.: US 2008/0270761 A1
(43) Pub. Date: Oct. 30, 2008

(54) Techniques to generate event contexts for recurring events

(75) Inventors: David J. Rasmussen, Redmond, WA (US); Alex J. Simmons, Seattle, WA (US); Christopher H. Pratley, Seattle, WA (US); Olya Veselova, Redmond, WA (US); Peyush Bansal, Redmond, WA (US); David Garber, Bellevue, WA (US); Igor Kofman, San Francisco, CA (US); Donovan Lange, Seattle, WA (US); Emily Pitler, McLean, VA (US); Kentaro Urata, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/796,768

(22) Filed: Apr. 30, 2007

(51) Int. Cl. G06F 9/30

(52) U.S. Cl. 712/209; 712/E09.005

(57) ABSTRACT

Techniques to generate event contexts for recurring events are described. A computer system may comprise a context management module with an event detection module to detect a first occurrence of an event, a context recording module to record context information for the event, the event detection module to detect a second occurrence of the event, and a context generator module to create an event context for the event with the context information during the second occurrence of the event. Other embodiments are described and claimed.

### BACKGROUND

User information may be created and maintained using many different application programs and systems. In some cases, information from one application program may be made available to another application program, essentially becoming shared or related information. Since shared or related information is managed by multiple application programs, however, accessing information from one application program by another application program could be inefficient or cumbersome from a user perspective. Consequently, there may be a need for improved techniques for managing and accessing shared information between multiple application programs in an efficient and effective manner to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques for automatically generating event contexts for recurring events. Some embodiments may be particularly directed to techniques for automatically generating event contexts for recurring events using context information. In one embodiment, for example, a context management module may include an event detection module to detect a first occurrence of an event, a context recording module to record context information for the event, the event detection module to detect a second occurrence of the event, and a context generator module to create an event context for the event with the context information during the second occurrence of the event. The context information may comprise, for example, any type of information that may be relevant to an event, such as any notes created during the event. Whenever the event detection module detects a second occurrence of the same event, the context generator module may be arranged to search for any context information (e.g., notes) associated with the event, and automatically display any associated context information during the second occurrence of the event. In this manner, an operator may quickly and easily have automatic access to relevant information from previous occurrences of the recurring event, while reducing or eliminating the need to rely upon memory recall or perform manual searches. Other embodiments are described and claimed.

### BRIEF DESCRIPTION OF THE DRAWINGS

FIG. 1 illustrates one embodiment of a computing system.

FIG. 2 illustrates one embodiment of a logic flow.

FIG. 3 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

Information workers often experience recurring events, such as recurring meetings or recurring phone calls with a client or manager, for example. Since such events are recurring, it may be useful to have access to any reference information or notes taken from a previous encounter. Some solutions allow a person to try and recover this previously recorded information when the event happens again for a second time, but these systems are entirely dependent on the author remembering several pieces of information. First, the person needs to remember that the specific event (e.g., meeting or phone call) had previously occurred. Second, the person needs to remember that they took notes or recorded other types of information related to the previous event. Third, the person needs to remember where the recorded information is stored. Such requirements may be tedious or time consuming for a user to remember. This may be particularly true given the volume of events that may occur throughout a given time period, and the length of time that may progress between certain recurring events. For example, assume a first phone call with a client prospect occurred more than one year prior to a second phone call with the same client prospect, thereby making it difficult or impossible for a user to remember that the first phone call occurred, the particular subject matter of the call, and where any notes on the call may have been recorded and stored. Further, such recall must be within a relatively short time span between answering the call and initiating a conversation with the caller. Also, often when an event happens, the person does not have a lot of time to look for related material, such as when the phone rings. A person typically does not want to ask the caller to wait until the old notes are located. Rather, such information should be available easily and quickly.

Various embodiments attempt to solve these and other problems by automatically creating an event context for recurring events. In one embodiment, for example, a context management module may include an event detection module to detect a first occurrence of an event, a context recording module to record context information for the event, the event detection module to detect a second occurrence of the event, and a context generator module to create an event context for the event with the context information during the second occurrence of the event. The context information may comprise, for example, any type of information that may be relevant to an event, such as any notes created during the event, supporting documents used or open during the event, any items or objects for application or system programs related to the event (e.g., a meeting reminder), graphic user interface (GUI) views used during the event, operator settings, application settings, certain software tools used during an event, and so forth. The context information may be used to generate a unique context event identifier for an event, thereby allowing the context generator module to search and locate context information related to the event based on the context event identifier. Whenever the event detection module detects a second occurrence of the same event, the context generator module may be arranged to search for any context information (e.g., notes) associated with the event using the appropriate event context identifier, and automatically display any associated context information during the second occurrence of the event.

In some embodiments, the context management module may create an event context for an event using context information derived from different application programs. For example, a computing system or device may include a first application program to create information such as notes for an operator, and a second application program to generate or display an event. In one embodiment, for example, the first and second application programs may be from the MICROSOFT® OFFICE suite of application programs, made by Microsoft Corporation, Redmond, Wash. An example of a first application program may include, but is not limited to, a MICROSOFT OUTLOOK® application program, usually referred to as MICROSOFT OUTLOOK. An example of a second application program may include, but is not limited to, a MICROSOFT OFFICE ONENOTE® application program, usually referred to as MICROSOFT ONENOTE. Although some embodiments may be described with these two application programs by way of example only, it may be appreciated that any application programs may be used and still fall within the scope of the embodiments.

In one embodiment, for example, the context management module may detect an event generated by the MICROSOFT OUTLOOK application program, such as a meeting reminder. The context management module may record context information in the form of notes taken for the event using the MICROSOFT ONENOTE application program. The context management module may associate the notes with the meeting reminder, and store the associated notes for the meeting. Whenever there is a recurrence of the same or similar meeting reminder, the context management module may perform a search to retrieve any notes associated with the previous meeting. The context management module may perform the search using, for example, an event context identifier assigned to the note. The context management module may retrieve any located notes, and display the related notes for the subsequent recurring event. In this manner, an operator may quickly and easily have automatic access to relevant information from previous occurrences of the recurring event, while reducing or eliminating the need to rely upon memory recall or perform manual searches.

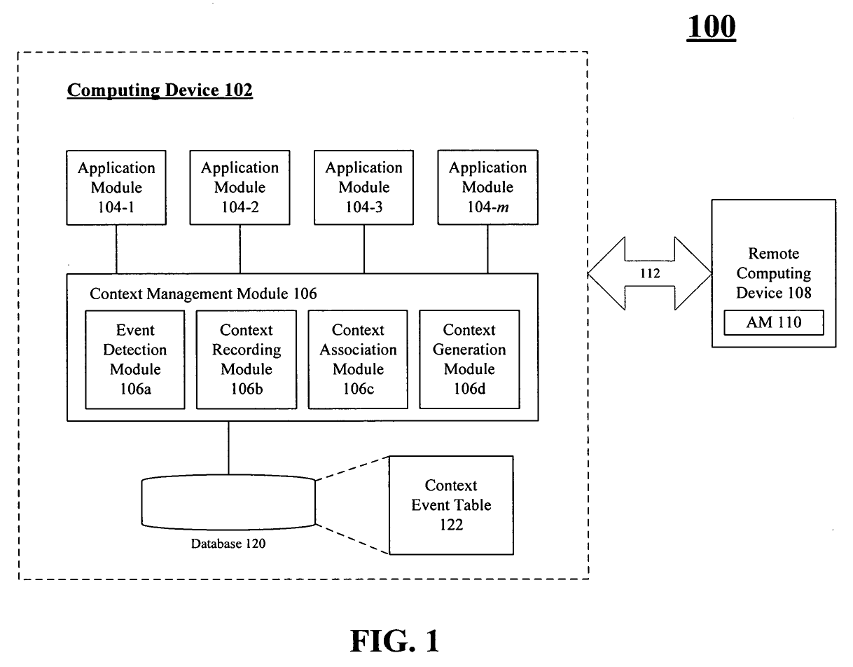

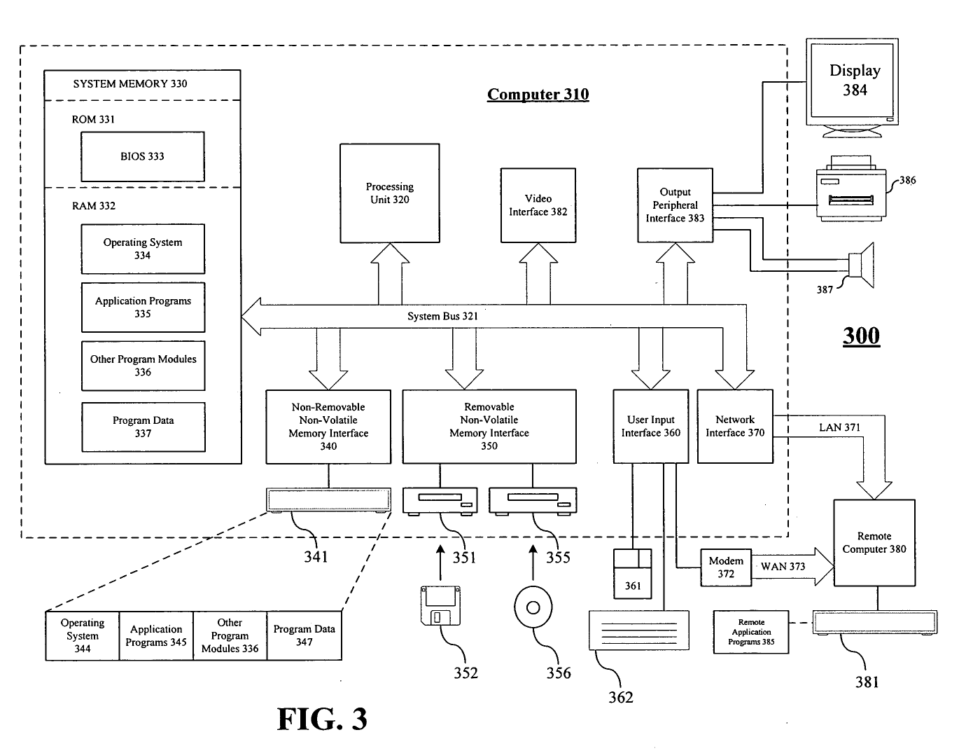

FIG. 1 illustrates a block diagram of a computing system 100. The computing system 100 may represent any computing system, architecture, or infrastructure arranged to store, process, communicate, and otherwise manage shared or associated information processes or operations for an electronic system or collection of electronic systems. As shown in FIG. 1, one embodiment of the computing system 100 may include a computing device 102 coupled to one or more remote computing devices 108. Computing device 102 may comprise two or more application modules 104-2-m coupled to a context management module 106. The context management module 106 may further comprise an event detection module 106a, a context recording module 106b, a context association module 106c, and a context generation module 106d. The context management module 106 may be communicatively coupled to a context database 120 storing an event context table 122. Remote computing device 108 may include an application module 110. In some cases, the modules 104, 110 may be the same or similar modules. In other cases, the modules 104, 110 may be arranged as client-server applications or peer-to-peer applications as desired for a given implementation. Additional details for one embodiment of computing device 102 and remote computing device 108 may be further illustrated and described with reference to FIG. 3.

As used herein the term “module” may include any structure implemented using hardware elements, software elements, or a combination of hardware and software elements. In one embodiment, for example, the modules described herein are typically implemented as software elements stored in memory and executed by a processor to perform certain defined operations. It may be appreciated that the defined operations may be implemented using more or less modules as desired for a given implementation. It may be further appreciated that the defined operations may be implemented using hardware elements based on various design and performance constraints. The embodiments are not limited in this context.

In various embodiments, the computing system 100 may be used to store, process, communicate, and otherwise manage shared information processes or operations between application programs 104-2-m and/or 110. With respect to computing device 102 and/or remote computing device 108, the context management module 106, the application programs 104-2-m and 110, and/or any shared or associated information (e.g., media context, data structures, data schemas, data files, and so forth) may be stored and accessed via any number of memory units, storage media, machine readable media, or computer-readable media implemented for a given computing device. The computing device 102 and remote computing device 108 may represent any type of electronic device having the appropriate hardware, software or combination hardware and software arranged to execute the operations of the application modules 104-2-m, the context management module 106, and/or the application module 110.

In various embodiments, the context management module 106 may allow the application modules 104-2-m and/or 110 to efficiently share or associate information, such as note information or notes with events. Note information may refer to any type of note such as a written reminder, which is typically a discrete set of information about an item, document or event. An event may refer to an occurrence of an event or action from an electronic device, such as hardware and/or software components of the computing devices 102, 108. For example, events may be generated by a computer program, such as an application program or system program executed by the computing device 102. Examples of events may include, without limitation, a meeting reminder, a telephone call, an email message, a document, an item, an object, audio, audio stream, video, video stream, and any other representation of a given action. In one embodiment, for example, the events may specifically refer to certain types of events that are capable of recurring, such as a telephone call from a communication device having a uniquely identifiable telephone number, listening to an audio stream, viewing a video presentation, and so forth.

In one embodiment, for example, an application module 104-1 may be implemented as any application program capable of generating a recurring event, such as a MICROSOFT OUTLOOK application program. The MICROSOFT OUTLOOK application program is a personal information manager (PIM). Although often used mainly as an email application, it also provides a calendar, task and contact management, note taking, and ajournal. It can be used as a stand-alone application, but can also operate in conjunction with Microsoft Exchange Server to provide enhanced functions for multiple users in an organization, such as shared mailboxes and calendars, public folders and meeting time allocation. The MICROSOFT OUTLOOK application program may be used to identify or generate many different types of recurring events. For example, one feature of the MICROSOFT OUTLOOK application program is that an operator may set meeting reminders for a certain date and time. In some cases, the meeting reminders may be recurring on a periodic basis, such as every other week, for example. Another feature of the MICROSOFT OUTLOOK application program is that an operator may communicate and manage email messages. In some cases, certain email messages may originate from the same sender, or there might be multiple replies on the same thread. An example of the latter case may be detecting a reply on an email thread. Yet another feature of the MICROSOFT OUTLOOK application program is that an operator may call a person from a contact list or item. In some cases, a person may be called multiple times. Each of these features provides an example of some form of recurring event.

In one embodiment, for example, an application module 104-2 may be implemented as a different application program, such as a MICROSOFT ONENOTE application program. The MICROSOFT ONENOTE application program is a tool for taking notes, information gathering, and multi-user collaboration. The notes may be categorized together into notebooks. In some cases, the MICROSOFT ONENOTE application program may be used to take various notes related to an event, such as a telephone call or meeting, for example.

In various embodiments, the context management module 106 may generate an event context for a recurring event using information from different application programs, such as the application programs 104-1, 104-2. In some implementations, the context management module 106 may be arranged to perform context management operations to automatically create an event context for recurring events. In one implementation, for example, the context management module 106 may detect a recurring event, and display any notes taken from a previous occurrence of the recurring event. In this manner, an operator may quickly and easily have automatic access to relevant information from previous occurrences of the recurring event, while reducing or eliminating the need to rely upon memory recall or perform manual searches.

In one embodiment, for example, the context management module 106 may include an event detection module 106a. The event detection module 106a may be arranged to detect any defined events generated by the computing device 102, such as one or more of the application programs 104-1-m. The event detection module 106a may be programmed to detect certain predefined events. The event detection module 106a may store when a defined event has occurred, and the how many times it has occurred, in the event context table 122 of the context database 120.

Assume by way of example a defined event includes a regularly occurring meeting reminder generated by the application program 104-1. The regularly occurring meeting reminder may be a company staff meeting that occurs every 9:00 AM on Monday. Whenever the application program 104-1 generates the recurring meeting reminder at 9:00 AM on a Monday, the event detection module 106a may recognize and detect the recurring meeting reminder as a defined event. The event detection module 106a may notify the context recording module 106b of the detected event, for example, by sending a detected event notification message to the context recording module 106b. Prior to generating the detected event notification message, the event detection module 106a may determine whether the detected event has previously occurred. If the detected event has previously occurred, then the event detection module 106a may retrieve an event context identifier associated with the event, and send the event context identifier with the detected event notification message. The event detection module 106a may also send a generate event context message to the context generating module 106d.

In one embodiment, for example, the context management module 106 may include a context recording module 106b. The context recording module 106b may be arranged to record any context information provided by the computing device 102, such as one or more of the application programs 104-1-m. The context information may comprise, for example, any type of information that may be relevant to an event, such as any notes created during the event, supporting documents used or open during the event, any items or objects for application or system programs related to the event (e.g., a meeting reminder), graphic user interface (GUI) views used during the event, operator settings, application settings, certain software tools used during an event, and so forth. The context information may further include GUI information for the GUI window used to display the context information (e.g., a note) when the context information was originally presented, such as position of a GUI window, size of a GUI window, a horizontal or vertical scroll position of a GUI window, and any other state information useful in replicating a context for the environment of the event as recorded when the context information was original recorded (e.g., a note was originally authored).

The context recording module 106b may receive the detected event notification message from the event detection module 106a. The context recording module 106b may determine whether the detected event notification message includes an event context identifier for the event. If the detected event notification message does not include an event context identifier, the context recording module 106b may generate a GUI view with a message requesting whether an operator would like initiate context recording operations for the new event. If the context recording module 106b receives an operator command or instruction to begin context recording operations, then the context recording module 106b may create a new record, data structure, or field to store context information for the new event in the event context table 122 of the context database 120. If the context recording module 106b does not receive an operator command to begin context recording operations, then the context recording module 106b may store a parameter indicating that the operator does not want to store context information for this particular event, and use the parameter to evaluate whether to prompt the operator again for a subsequent recurrence of the event. The context recording module 106b may store the parameter in the event context table 122 of the context database 120.

If the detected event notification message does include an event context identifier, the context recording module 106b may generate a GUI view with a message requesting whether an operator would like to continue context recording operations for the recurring event. If the context recording module 106b receives an operator command to continue context recording operations for the recurring event, the context recording module 106b may retrieve the previously stored context information using the event context identifier provided by the detected event notification message, begin context recording operations, and append the additional context information to the previously recorded context information. If the context recording module 106b does not receive an operator command to continue context recording operations, then the context recording module 106b may store a parameter indicating that the operator does not want to store additional context information for this particular event, and use the parameter to evaluate whether to prompt the operator again for a subsequent recurrence of the event. The context recording module 106b may store the parameter in the event context table 122 of the context database 120.

In some cases, the context recording module 106b may record context information from one or more of the application programs 104-1-m. In one embodiment, for example, the context recording module 106b may record notes taken using the MICROSOFT ONENOTE application program 104-2. This may be accomplished in a number of different ways. For example, the context recording module 106b may store the notes directly in the event context table 122. In this case, conversion operations may be needed to ensure the appropriate data format. In another example, the context recording module 106b may store a pointer and/or method to the notebook used to store the notes by the application program 104-2. In this case, the pointer and/or method may be used to retrieve the appropriate notes from the application program 104-2, or prompt execution of the application program 104-2 to display the associated notes. The embodiments are not limited in this context.

In various implementations, the context recording module 106b may implement logic to start recording context information based on a variety of entry points. For example, the context recording module 106b may start recording context information in response to an operator command or instruction, a global default value set for the context management module 106, a specific default value set for a defined event or type of defined event, a timer value set for a defined time period from when an event was detected, and so forth. Alternatively, a set of context recording rules may be implemented to determine when to start and/or stop recording context information.

In one embodiment, for example, the context management module 106 may include a context association module 106c. The context association module 106c may be arranged to associate any context information provided by the computing device 102, such as one or more of the application programs 104-1-m, with a given event. Once the context recording module 106b records context information for an event, the context association module 106c may generate an event context identifier for an event using the context information recorded by the context recording module 106b. The event context identifier may be used for various file management operations, such as creating a file, reading a file, writing to a file, indexing a file, searching or locating a file, and so forth. The event context identifier may comprise any unique identifier, such as a globally unique identifier (GUID), that may be used to represent an event and/or a set of context information. The context association module 106c may use the generated event context identifier to associate a set of context information with an event and vice-versa, store the context information to the event context table 122, and retrieve the context information for recurring events from the event context table 122.

In one embodiment, for example, the context association module 106c may use the same event context identifier for all context information stored for any occurrence of an event. In one embodiment, for example, the context association module 106c may use a different event context identifier for separate sets of context information stored for a given occurrence of an event. For example, an event context identifier may identify all the notes taken for all occurrences of an event, or an event context identifier may identify those notes taken for each occurrence of an event. In the latter case, the event context identifiers may be related. For example, the context association module 106c may assign version numbers to each event context identifier used to identify notes for each occurrence of an event. The context association module 106c may store the event context identifiers in a table, or pass the event context identifiers to the event detection module 106a for storage and management.

In one embodiment, for example, the context management module 106 may include a context generating module 106d. The context generating module 106d may be arranged to generate an event context for a given event using any context information associated with the event. When the event detection module 106a detects a recurring event, the event detection module 106a may send a generate event context message to the context generating module 106d. The event detection module 106a may determine that an event is a recurring event using the information stored in the event context table 122 of the context database 120. The context generating module 106d may receive the generate event context message from the event detection module 106a, and initiate search operations to determine whether any context information is associated with the event. This may be accomplished, for example, using the event context identifier. If the context generating module 106d locates any context information in the event context table 122, it may retrieve the stored context information from the event context table 122, and generate the appropriate event context.

By way of example, the context generating module 106d may locate previous notes stored in the event context table 122 or by the application program 104-2, and display the notes in a GUI note view. The GUI note view may be generated by the application program 104-1, the context management module 106, and/or the application program 104-2, depending upon how the notes were stored when recorded by the context recording module 106b. For example, if the context recording module 106b stored a pointer and method for the associated notes, the context generating module 106d may execute the method (e.g., an API) to retrieve the appropriate notes from the application program 104-2, or prompt execution of the application program 104-2 to display the associated notes in a native format. In some cases, the context information may further include GUI information for the GUI window used to display the note when the note was originally authored, such as position of a GUI window, size of a GUI window, a horizontal or vertical scroll position of a GUI window, and any other state information useful in replicating a context for the environment of the event as recorded when the note was originally authored.

Operations for the computing system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the computing system 100 or alternative elements as desired for a given set of design and performance constraints.

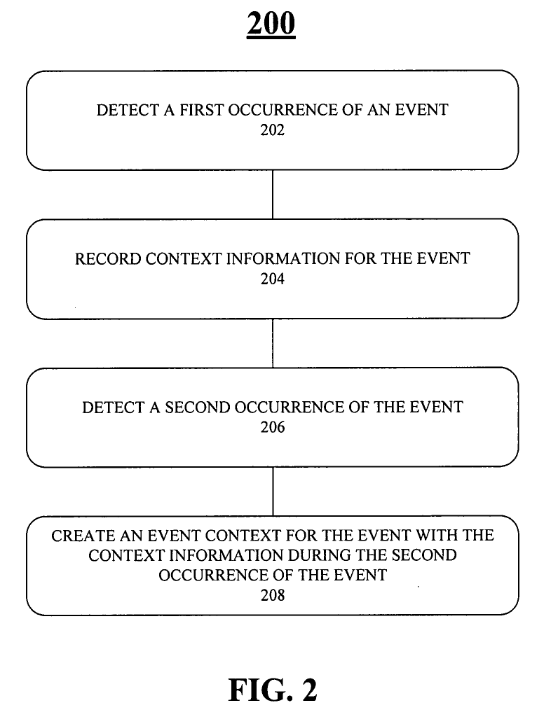

FIG. 2 illustrates a logic flow 200. The logic flow 200 may be representative of the operations executed by one or more embodiments described herein. As shown in FIG. 2, the logic flow 200 may detect a first occurrence of an event at block 202. For example, the event may be a defined event for the application program 104-1. The logic flow 200 may record context information for the event at block 204. For example, the context information may include a note from the application program 104-2. The logic flow 200 may detect a second occurrence of the event at block 206. The logic flow 200 may create an event context for the event with the context information during the second occurrence of the event at block 208. For example, the event context may be created by searching, retrieving and displaying any context information associated with the event using an event context identifier. The embodiments are not limited in this context.

FIG. 3 illustrates a block diagram of a computing system architecture 300 suitable for implementing various embodiments, including the computing system 100. It may be appreciated that the computing system architecture 300 is only one example of a suitable computing environment and is not intended to suggest any limitation as to the scope of use or functionality of the embodiments. Neither should the computing system architecture 300 be interpreted as having any dependency or requirement relating to any one or combination of components illustrated in the exemplary computing system architecture 300.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 3, the computing system architecture 300 includes a general purpose computing device such as a computer 310. The computer 310 may include various components typically found in a computer or processing system. Some illustrative components of computer 310 may include, but are not limited to, a processing unit 320 and a memory unit 330.

In one embodiment, for example, the computer 310 may include one or more processing units 320. A processing unit 320 may comprise any hardware element or software element arranged to process information or data. Some examples of the processing unit 320 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 320 may be implemented as a general purpose processor. Alternatively, the processing unit 320 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 310 may include one or more memory units 330 coupled to the processing unit 320. A memory unit 330 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 310. The embodiments are not limited in this context.

In one embodiment, for example, the computer 310 may include a system bus 321 that couples various system components including the memory unit 330 to the processing unit 320. A system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 310 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 300. Examples of computer readable media for computing system architecture 300 may include, but are not limited to, volatile and/or nonvolatile memory such as ROM 331 and RAM 332. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 330 includes computer storage media in the form of volatile and/or nonvolatile memory such as ROM 331 and RAM 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 331 or other type of display device is also connected to the system bus 321 via an interface, such as a video interface 330. In addition to the monitor 331, computers may also include other peripheral output devices such as speakers 337 and printer 336, which may be connected through an output peripheral interface 330.

The computer 310 may operate in a networked environment using logical connections to one or more remote computers, such as a remote computer 380. The remote computer 380 may be a personal computer (PC), a server, a router, a network PC, a peer device or other common network node, and typically includes many or all of the elements described above relative to the computer 310, although only a memory storage device 381 has been illustrated in FIG. 3 for clarity. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other technique suitable for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other techniques for establishing a communications link between the computers may be used. Further, the network connections may be implemented as wired or wireless connections. In the latter case, the computing system architecture 300 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system 100 and/or computing system architecture 300 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
detecting a first occurrence of an event;
recording context information for the event;
detecting a second occurrence of the event; and
creating an event context for the event with the context information during the second occurrence of the event.

2. The method of claim 1, comprising recording a note as the context information for the event.

3. The method of claim 1, comprising generating an event context identifier for the event using the context information.

4. The method of claim 1, comprising associating the context information with the event using an event context identifier.

5. The method of claim 1, comprising creating the event context by displaying the associated context information for the event.

6. The method of claim 1, comprising searching for context information associated with the event using an event context identifier for the event.

7. The method of claim 1, comprising displaying a graphic user interface view to indicate associated context information is available for the event.

8. An article comprising a storage medium containing instructions that if executed enable a system to:
detecting a first occurrence of an event;
recording context information for the event;
associating the context information with the event;
detecting a second occurrence of the event; and
creating an event context for the event using the context information.

9. The article of claim 8, further comprising instructions that if executed enable the system to record a note as the context information for the event.

10. The article of claim 8, further comprising instructions that if executed enable the system to generate an event context identifier for the event using the context information.

11. The article of claim 8, further comprising instructions that if executed enable the system to associate the context information with the event using an event context identifier.

12. The article of claim 8, further comprising instructions that if executed enable the system to create the event context by displaying the associated context information for the event.

13. The article of claim 8, further comprising instructions that if executed enable the system to search for context information associated with the event using an event context identifier for the event.

14. The article of claim 8, further comprising instructions that if executed enable the system to display a graphic user interface view to indicate associated context information is available for the event.

15. A computer system comprising a context management module with an event detection module to detect a first occurrence of an event, a context recording module to record context information for the event, the event detection module to detect a second occurrence of the event, and a context generator module to create an event context for the event with the context information during the second occurrence of the event.

16. The computer system of claim 15, comprising a first application program to generate the event.

17. The computer system of claim 15, comprising a second application program to generate a note for the event, the context recording module to record the note as the context information for the event.

18. The computer system of claim 15, the context association module to generate an event context identifier for the event using the context information.

19. The computer system of claim 15, the context association module to associate the context information with the event using an event context identifier.

20. The computer system of claim 15, the context generation module to generate the event context by searching for context information associated with the event using an event context identifier, and display the associated context information.
